(19) United States
(12) Patent Application Publication
(10) Pub. No.: US 2026/0091666 A1
(43) Pub. Date: Apr. 2, 2026

(54) CAPLESS FUEL FILLER ASSEMBLY

(71) Applicant: Nissan Motor Co., Ltd., Yokohama-shi, Kanagawa (JP)

(72) Inventors: Masanori SAKURAI, Kanagawa (JP); Fumihiko SATO, Kanagawa (JP); Yusuke YAMASHINA, Kanagawa (JP)

(21) Appl. No.: 19/112,990

(22) PCT Filed: Sep. 29, 2022
(86) PCT No.: PCT/JP2022/036583

§ 371 Date: Mar. 19, 2025

(51) Int. Cl. B60K 15/04; B60K 15/03

(52) U.S. Cl. CPC B60K 15/04; B60K 2015/03269; B60K 2015/0461; B60K 2015/0477

(57) ABSTRACT

A capless fuel filler assembly is attached to a distal end of a filler pipe extending from a fuel tank. The capless fuel filler assembly includes a main body, a flap valve, and a pair of stopper ribs. The main body has a fuel filler through which a nozzle of a filler gun is inserted. The flap valve is disposed in the main body such that the flap valve can be opened and closed, and the flap valve opens and closes the fuel filler. The stopper ribs project inward from an inner surface of a flow path of a liquid fuel formed in the main body. The pair of stopper ribs project inward toward each other, and regulate an insertion depth of the nozzle. The shortest distance between the pair of stopper ribs is smaller than an outer diameter of a distal end of the nozzle.

### CROSS-REFERENCE TO RELATED APPLICATIONS

This application is a U.S. national stage application of International Application No. PCT/JP2022/036583, filed on Sep. 29, 2022.

### BACKGROUND

### Technical Field

The present invention relates to a capless fuel filler assembly for a vehicle.

### Background Information

In a conventional vehicle, a cap is screwed to a fuel filler at an upper end of a filler pipe extending from a fuel tank toward the side of the vehicle body to close the fuel filler. Recently, a vehicle in which a capless fuel filler assembly is attached to an upper end of a filler pipe is also commercially available. The capless fuel filler assembly has a flapper nozzle which is pushed and opened by a nozzle of a filler gun, instead of a cap screwed to a fuel filler. Due to having a flap valve which is opened by pushing the nozzle of the filler gun, the capless fuel filler assembly is easy to use. Japanese Patent Application Publication No. 2012-86748 A (Patent Literature 1) discloses a capless fuel filler assembly.

### SUMMARY

A filler gun has a function for automatically stopping fuel filling at a distal end thereof. The automatic stop function is for automatically stopping fuel filling by detecting a liquid level of a liquid fuel in a filler pipe. In a mechanism for implementing the automatic stop function, gas (air and evaporated fuel) is sucked from an intake hole which is opened at the vicinity of a distal end of a nozzle of a filler gun by using the negative pressure generated by the venturi effect caused by the flow of a liquid fuel during fuel filling. When the liquid level of the liquid fuel reaches the intake hole, the gas is no longer sucked. Therefore, fuel filling is stopped by using the pressure change at that time. However, depending on the internal shape of the filler pipe or fuel filler assembly and the shape of the filler gun, the intake hole may be closed by a liquid fuel flowing out of the nozzle of the filler gun. In this case, malfunction of an automatic stop function occurs due to a liquid fuel flowing out of the nozzle, instead of a normal operation of the automatic stop function by the liquid level rising in the filler pipe. In a case of a fuel filling station where a user of a vehicle performs fuel filling by himself/herself, this kind of malfunction is very inconvenient.

An object of the present invention is to provide a capless fuel filler assembly capable of preventing malfunction of an automatic stop function of a fueling machine.

### Technical Solution

A capless fuel filler assembly according to a first feature of the present invention is attached to a distal end of a filler pipe extending from a fuel tank. The capless fuel filler assembly includes a main body, a flap valve, and a pair of stopper ribs. The main body has a fuel filler through which a nozzle of a filler gun is inserted. The flap valve is disposed in the main body such that the flap valve can be opened and closed, and the flap valve opens and closes the fuel filler. The pair of stopper ribs project inward from an inner surface of a flow path of a liquid fuel formed in the main body. The pair of stopper ribs project inward toward each other, and regulate an insertion depth of the nozzle. The shortest distance between the pair of stopper ribs is set to be smaller than an outer diameter of a distal end of the nozzle.

A capless fuel filler assembly according to a second feature of the present invention is attached to a distal end of a filler pipe extending from a fuel tank. The capless fuel filler assembly includes a main body, a flap valve, and at least one stopper rib. The main body has a fuel filler through which a nozzle of a filler gun is inserted. The flap valve is disposed in the main body such that the flap valve can be opened and closed, and the flap valve opens and closes the fuel filler. The stopper rib projects inward from an inner surface of a flow path of a liquid fuel formed in the main body, and regulates an insertion depth of the nozzle. The shortest distance between the stopper rib and the inner surface of the flow path facing a distal end of the stopper rib is set to be smaller than an outer diameter of a distal end of the nozzle.

According to the above features, it is possible to prevent malfunction of an automatic stop function of a fueling machine.

### BRIEF DESCRIPTION OF DRAWINGS

Referring now to the attached drawings which form a part of this original disclosure, illustrative embodiments are shown.

FIG. 1 is a cross-sectional view of a capless fuel filler assembly according to a first embodiment.

FIG. 2 is a cross-sectional view which is taken along line II-II in FIG. 1.

FIG. 3 is a cross-sectional view (corresponding to FIG. 2) of a capless fuel filler assembly according to a second embodiment.

FIG. 4 is a cross-sectional view (corresponding to FIG. 2) of a capless fuel filler assembly according to a modified example of the first embodiment.

FIG. 5 is a cross-sectional view (corresponding to FIG. 2) of a capless fuel filler assembly according to a modified example of the second embodiment.

### DETAILED DESCRIPTION OF EMBODIMENTS

A capless fuel filler assembly (hereinafter simply referred to as “assembly”) according to embodiments will be described below with reference to the drawings.

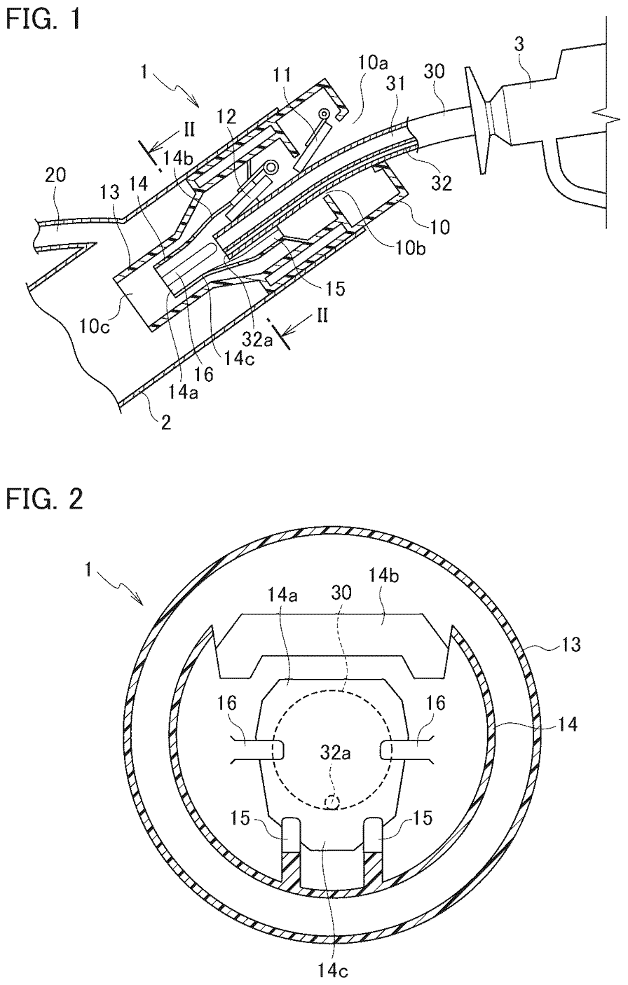

First, a filler gun will be described. The shape of a nozzle of the filler gun is roughly specified in the International Standard ISO (ISO9158, ISO9159). The nozzle is curved in the middle and has a straight portion at a distal end thereof. An outer diameter of the nozzle is 21 mm for gasoline and 24 mm for diesel, and these seem to be globally uniform. A curvature range of the curved portion and a length range of the straight portion are specified in the standard. With regard to an automatic stop mechanism, it is specified in the standard that a position of the intake hole is within 22 mm from the distal end of the nozzle. The intake hole is located inside the curvature of the nozzle, but the intake hole may be opened at an end of the nozzle (see FIG. 1), or may be opened on an outer peripheral surface of the nozzle. National standards are determined based on the ISO (SAE in US, JIS in Japan, and the like).

With reference to FIGS. 1 and 2, an assembly 1 according to a first embodiment will be described. The assembly 1 is attached to an end of a filler pipe 2 extending upward from a fuel tank (not shown). A liquid fuel supplied by a filler gun 3 through the assembly 1 flows down into the interior of the filler pipe 2 and then is stored in the fuel tank. At this time, a gas in the fuel tank is refluxed to the vicinity of the end of the filler pipe 2 by a breather pipe 20 to facilitate the filling of a liquid fuel. A lower end of the filler pipe 2 is connected to a lower part of the fuel tank, and a check valve is disposed thereto. A lower end of the breather pipe 20 is connected to an upper part of the fuel tank.

The assembly 1 includes a main body 10 made of a resin. Although FIG. 1 shows the main body 10 as a single component, the main body 10 is actually composed of a plurality of resin components. The main body 10 is a cylindrical member which is tapered toward the fuel tank. Further, the main body 10 of the present embodiment has a double-cylinder structure including an outer cylinder 13 and an inner cylinder 14. A fuel filler 10a through which a nozzle 30 of the filler gun 3 is inserted is formed in one end of the main body 10. An outer flap valve 11 for closing the fuel filler 10a is disposed in the main body 10. The swingable outer flap valve 11 is attached in the main body 10 such that the outer flap valve 11 can be opened and closed, and the outer flap valve 11 is always energized by a torsion coil spring so as to close the fuel filler 10a.

The main body 10 of the assembly 1 of the present embodiment has therein an inner flap valve 12, in addition to the outer flap valve 11. The inner flap valve 12 is located closer to the fuel tank than the outer flap valve 11. The inner flap valve 12 is also swingably attached in the main body 10 by a torsion coil spring, and the inner flap valve 12 is always energized so as to close an intermediate hole 10b formed in the main body 10. When the nozzle 30 of the filler gun 3 is inserted into the main body 10 through the fuel filler 10a, both of the outer flap valve 11 and the inner flap valve 12 are pushed and opened by the nozzle 30. When the nozzle 30 is pulled out of the main body 10, both of the outer flap valve 11 and the inner flap valve 12 are closed by a torsion coil spring, and the fuel filler 10a and the intermediate hole 10b are closed by the outer flap valve 11 and the inner flap valve 12, respectively.

A portion of the main body 10 closer to the fuel tank than the intermediate hole 10b has a double-cylinder structure including the outer cylinder 13 and the inner cylinder 14, as described above. The inner cylinder 14 is also referred to as a flow guide. An inner diameter of the outer cylinder 13 gradually decreases toward a discharge opening 10c formed at a distal end thereof. An outer diameter of the inner cylinder 14 is smaller than the inner diameter of the outer cylinder 13. An inner diameter of the inner cylinder 14 also gradually decreases toward a discharge opening 14a formed at a distal end thereof. A gradually changing range of the inner diameter of the outer cylinder 13 and a gradually changing range of the inner diameter of the inner cylinder 14 substantially coincide with each other along a liquid fuel flow path formed in the main body 10.

An opening 14b for avoiding interference with the opened inner flap valve 12 is formed in an upper part of the inner cylinder 14 when the assembly 1 is attached to a vehicle. Meanwhile, a notch 14c which is continuous from the discharge opening 14a is formed at a lower part of the inner cylinder 14. A pair of guide ribs 15 are formed at the lower part of the inner cylinder 14 from upper end edges thereof to the notch 14c. The guide ribs 15 guide the insertion of the nozzle 30 and extend parallel to the liquid fuel flow path. A flow path 31 of a liquid fuel is formed in the nozzle 30, and as shown in FIG. 1, an intake passage 32 for automatic stop of fuel filling is further formed in the flow path 31. A distal end of the intake passage 32 serves as an intake hole 32a, and in the present embodiment, the intake hole 32a is opened at a distal end of the nozzle 30.

A pair of stopper ribs 16 are formed inward from an inner peripheral surface of the inner cylinder 14, that is, from an inner surface of the liquid fuel flow path. The pair of stopper ribs 16 project inward toward each other from inner side surfaces of the inner cylinder 14, when the assembly 1 is attached to the vehicle. As shown in FIG. 2, the shortest distance between the pair of stopper ribs 16 is set to be smaller than an outer diameter of a distal end of the nozzle 30. The pair of stopper ribs 16 abut against the nozzle 30 and regulate the insertion depth of the nozzle 30. End edges of the stopper ribs 16 which abut against the distal end of the nozzle 30 are located in the gradually changing range of the inner diameter of the inner cylinder 14 described above. The stopper ribs 16 extend to the discharge opening 14a. FIG. 2 shows only the cross section of the main body 10 and does not show the filler pipe 2.

A description will be given regarding the relationship between the assembly 1 and the inserted nozzle 30, and the prevention of malfunction of automatic stop of fuel filling.

During fuel filling, the nozzle 30 is inserted into the main body 10 through the fuel filler 10a. The outer flap valve 11 and the inner flap valve 12 are pushed and opened by the nozzle 30 in order, and then the distal end of the nozzle 30 is inserted into the inner cylinder 14. The nozzle 30 of the filler gun 3 is curved downward, and the distal end of the nozzle 30 is inserted further into the inner cylinder 14 while being in contact with upper edges of the pair of guide ribs 15 and being guided by the pair of guide ribs 15. Since the distal end of the nozzle 30 is guided by the pair of guide ribs 15, the distal end of the nozzle 30 reliably abuts against the pair of stopper ribs 16. The shortest distance between the pair of stopper ribs 16 is set to be smaller than an outer diameter of the distal end of the nozzle 30. Therefore, even if the distal end of the nozzle 30 is not effectively guided by the guide ribs 15, the distal end of the nozzle 30 reliably abuts against at least one of the stopper ribs 16. As a result, the insertion depth of the nozzle 30 is regulated.

When the distal end of the nozzle 30 abuts against the stopper ribs 16, an outer peripheral surface of the distal end of the nozzle 30 is sufficiently distant from an inner peripheral surface of the inner cylinder 14 and an inner peripheral surface of the outer cylinder 13. Therefore, the intake hole 32a which is opened at the distal end of the nozzle 30 is also sufficiently distant from the inner peripheral surfaces. Even if the filler gun 3 is slightly rotated around an axis of the nozzle 30 when the nozzle 30 is inserted, the intake hole 32a is sufficiently distant from the inner peripheral surfaces. If the distance between the intake hole 32a and the inner peripheral surfaces is short, a liquid fuel which passes through the flow path 31 of the nozzle 30 and which is discharged collides with the inner peripheral surfaces. Accordingly, the flow of the liquid fuel is disrupted, the intake hole 32a is closed by the liquid fuel, and malfunction of the automatic stop may occur. In this case, since the intake hole 32a is sufficiently distant from the inner peripheral surfaces, malfunction can be avoided.

If the insertion depth of the nozzle 30 is not regulated and the nozzle 30 can be inserted to a deep part, the intake hole 32a comes into contact with the inner peripheral surfaces, or the distance between the intake hole 32a and the inner peripheral surfaces becomes very small due to the curvature of the nozzle 30. In the present embodiment, since the insertion depth of the nozzle 30 is regulated, the intake hole 32a and the inner peripheral surfaces can be sufficiently separated. In particular, in the present embodiment, since the pair of guide ribs 15 are formed, the intake hole 32a and the inner peripheral surfaces can be reliably separated. Further, since the notch 14c is formed behind the guide ribs 15, there is no inner peripheral surface of the inner cylinder 14 below the distal end of the nozzle 30, and the distance between the nozzle 30 and the inner peripheral surface of the outer cylinder 13 is sufficiently ensured. Similarly, even when the intake hole 32a is opened on an outer peripheral surface in the vicinity of the distal end of the nozzle 30 without being opened at the distal end of the nozzle 30 as in the present embodiment, the malfunction of the automatic stop can be avoided.

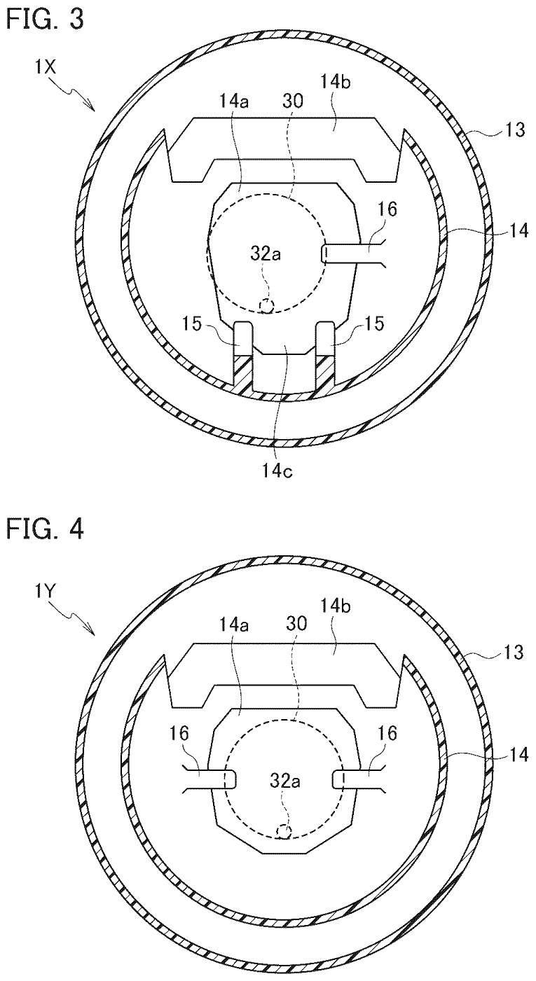

Next, with reference to FIG. 3, an assembly 1X according to a second embodiment will be described. Only configurations different from those of the first embodiment will be described below. Configurations which are the same as or similar to the configurations of the first embodiment are denoted with the same reference numerals, and detailed descriptions thereof will be omitted.

In the first embodiment described above, the pair of stopper ribs 16 facing each other are formed. In the present embodiment, a single stopper rib 16 is formed. The shortest distance between the stopper rib 16 and an inner surface of a liquid fuel flow path facing a distal end of the stopper rib 16 (inner peripheral surface of inner cylinder 14) is set to be smaller than an outer diameter of the distal end of the nozzle 30. The insertion of the nozzle 30 is guided by the pair of guide ribs 15, and the distal end of the nozzle 30 abuts against the stopper rib 16 to regulate the insertion depth of the nozzle 30. The shortest distance between the stopper rib 16 and the inner surface of the liquid fuel flow path facing the distal end of the stopper rib 16 (inner peripheral surface of inner cylinder 14) is set to be smaller than the outer diameter of the distal end of the nozzle 30. Therefore, even if the distal end of the nozzle 30 is displaced in a radial direction, the distal end of the nozzle 30 reliably abuts against the stopper rib 16, as shown in FIG. 3. As a result, since the insertion depth of the nozzle 30 is regulated and the intake hole 32a is sufficiently separated from the inner peripheral surface, malfunction can be avoided.

Next, with reference to FIG. 4, an assembly 1Y according to a modified example of the first embodiment will be described. Only configurations different from those of the first embodiment will be described below. Configurations which are the same as or similar to the configurations of the first embodiment are denoted with the same reference numerals, and detailed descriptions thereof will be omitted.

In the first embodiment described above, the guide ribs 15 and the notch 14c are formed, but guide ribs and a notch are not formed in the present embodiment. It is preferable to form the guide ribs 15 and the notch 14c, because it is possible to more reliably separate the intake hole 32a from the inner peripheral surface. However, it is not necessary to form the guide ribs 15 and the notch 14c as in the present embodiment. Since the shortest distance between the pair of stopper ribs 16 is set to be smaller than the outer diameter of the distal end of the nozzle 30, even if the distal end of the nozzle 30 is not guided by the guide ribs 15, the distal end of the nozzle 30 reliably comes into contact with at least one of the stopper ribs 16. As a result, since the insertion depth of the nozzle 30 is regulated and the intake hole 32a is sufficiently separated from the inner peripheral surface, malfunction can be avoided.

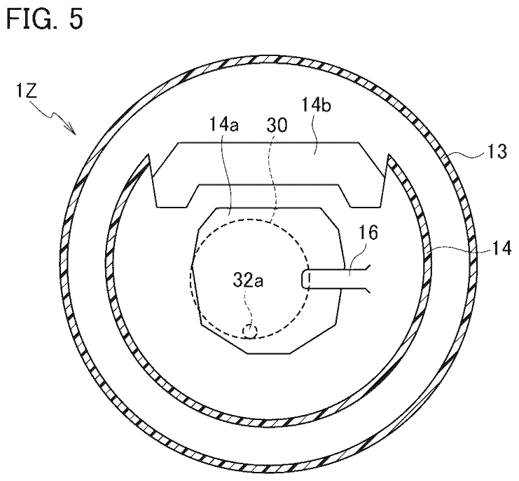

Next, with reference to FIG. 5, an assembly 1Z according to a modified example of the second embodiment will be described. Only configurations different from those of the second embodiment will be described below. Configurations which are the same as or similar to the configurations of the second embodiment are denoted with the same reference numerals, and detailed descriptions thereof will be omitted.

In the second embodiment described above, the guide ribs 15 and the notch 14c are formed, but guide ribs and a notch are not formed in the present embodiment. It is preferable to form the guide ribs 15 and the notch 14c, because it is possible to more reliably separate the intake hole 32a from the inner peripheral surface. However, it is not necessary to form the guide ribs 15 and the notch 14c. The distal end of the nozzle 30 abuts against the stopper rib 16 to regulate the insertion depth of the nozzle 30. The shortest distance between the stopper rib 16 and the inner surface of the liquid fuel flow path facing the distal end of the stopper rib 16 (inner peripheral surface of inner cylinder 14) is set to be smaller than the outer diameter of the distal end of the nozzle 30. Therefore, even if the distal end of the nozzle 30 is displaced in a radial direction, the distal end of the nozzle 30 reliably abuts against the stopper rib 16, as shown in FIG. 5. As a result, since the insertion depth of the nozzle 30 is regulated and the intake hole 32a is sufficiently separated from the inner peripheral surface, malfunction can be avoided.

In all of the above-described embodiments and modified examples, an end of each stopper rib 16 is disposed in the gradually changing ranges of the inner diameters of the outer cylinder 13 and the inner cylinder 14. Although the intake hole 32a is disposed in the vicinity of the distal end of the nozzle 30 inside the curvature of the nozzle 30, when the nozzle 30 is inserted to a deep part, the nozzle 30 tends to be fixed, while the intake hole 32a is in contact with the inner peripheral surface due to the curvature of the nozzle 30 and the decrease in the inner diameter of the flow path. However, when an end of each stopper rib 16 is disposed in a gradually changing range, the insertion depth of the nozzle 30 is regulated, and maintenance of the contact state between the intake hole 32a and the inner peripheral surface is easily avoided. Further, since the nozzle 30 is not inserted to a deep part, it is possible to avoid fixing of a position of the nozzle 30, even when the nozzle 30 is curved without being affected by the decrease in the inner diameter of the flow path. Therefore, even when the distal end of the nozzle 30 is in contact with each stopper rib 16, the distal end of the nozzle 30 can be displaced in a radial direction to separate the intake hole 32a from the inner peripheral surface, and this can more reliably avoid malfunction.

Further, in all of the above-described embodiments and modified examples, the pair of stopper ribs 16 project inward from side wall surfaces of the inner cylinder 14 when the assembly 1 (1X to 1Z) is attached to the vehicle, instead of projecting from a lower wall surface. Therefore, when the nozzle 30 is inserted, the stopper ribs 16 are not located in the vicinity of the intake hole 32a located below. Further, the stopper ribs 16 do not block the flow of the liquid fuel, and thus the liquid fuel does not close the intake hole 32a.

The assembly 1 of the first embodiment and the assembly 1Y of the modified example of the first embodiment have the pair of stopper ribs 16 projecting inward from the inner surface of the flow path of the liquid fuel (inner peripheral surface of inner cylinder 14) formed in the main body 10. The pair of stopper ribs 16 project toward each other. The shortest distance between the pair of stopper ribs 16 is set to be smaller than the outer diameter of the distal end of the nozzle 30. Therefore, the insertion depth of the nozzle 30 is regulated by the pair of facing stopper ribs 16, and the intake hole 32a of the nozzle 30 can be sufficiently separated from the inner surface of the flow path (inner peripheral surface of inner cylinder 14). As a result, it is possible to reliably prevent the liquid fuel discharged from the flow path 31 of the nozzle 30 from bouncing back to the inner surface of the flow path (inner peripheral surface of inner cylinder 14) so that the liquid fuel does not close the intake hole 32a. Therefore, it is possible to reliably avoid the malfunction of an automatic stop function of a fueling machine.

In the assembly 1X of the second embodiment and the assembly 1Z of the modified example of the second embodiment, at least one stopper rib 16 projects inward from the inner surface of the liquid fuel flow path (inner peripheral surface of inner cylinder 14) formed in the main body 10. The shortest distance between the stopper rib 16 and the inner surface of the flow path facing a distal end of the stopper rib 16 (inner peripheral surface of inner cylinder 14) is set to be smaller than the outer diameter of the distal end of the nozzle 30. Therefore, the insertion depth of the nozzle 30 is regulated by the stopper rib 16, and the intake hole 32a can be sufficiently separated from the inner surface of the flow path (inner peripheral surface of inner cylinder 14). As a result, it is possible to reliably prevent the liquid fuel discharged from the flow path 31 of the nozzle 30 from bouncing back to the inner surface of the flow path (inner peripheral surface of inner cylinder 14) so that the liquid fuel does not close the intake hole 32a. Therefore, it is possible to avoid the malfunction of an automatic stop function of a fueling machine.

In particular, in the assembly 1 of the first embodiment and in the assembly 1X of the second embodiment, the pair of guide ribs 15 for guiding the insertion of the nozzle 30, which extend parallel to the flow path are formed on the inner surface of the flow path (inner peripheral surface of inner cylinder 14). Since the insertion of the nozzle 30 is guided by the guide ribs 15, the distal end of the nozzle 30 can more reliably abut against each stopper rib 16. Therefore, it is possible to more reliably avoid the malfunction of an automatic stop function of a fueling machine. Further, the intake hole 32a of the nozzle 30 can be reliably separated from the inner surface of the flow path (inner peripheral surface of inner cylinder 14) by the guide ribs 15. Therefore, it is also possible to more reliably avoid the malfunction of an automatic stop function of a fueling machine from this point as well.

The present invention is not limited to the above-described embodiments. It is sufficient if an assembly has at least one stopper rib 16, and the assembly may have two stopper ribs 16 as in the first embodiment and the modified example thereof, or the assembly may have three or more stopper ribs 16. When the assembly has two stopper ribs 16, the advantages described above can be provided if the two stopper ribs 16 are disposed so as to face each other as in the first embodiment and the modified example thereof. In addition, in the above-described embodiments, the assembly has the inner flap valve 12 in addition to the outer flap valve 11 for opening and closing the fuel filler 10a. It is preferable if the assembly has two flap valves, because the release of an evaporated fuel in a fuel tank to the atmosphere can be more reliably prevented. However, the assembly may have only the outer flap valve 11 for opening and closing the fuel filler 10a without having the inner flap valve 12. Further, in the above-described embodiments, the main body 10 has a double-cylinder structure formed by the outer cylinder 13 and the inner cylinder 14. However, the main body 10 may have a short-cylinder structure instead of the double-cylinder structure.

1. A capless fuel filler assembly configured to be attached to a distal end of a filler pipe extending from a fuel tank, the capless fuel filler assembly comprising:
a main body having a fuel filler through which a nozzle of a filler gun is inserted;
a flap valve for opening and closing the fuel filler, that is disposed in the main body such that the flap valve can be opened and closed;
a pair of stopper ribs that project inward from an inner surface of a flow path of a liquid fuel formed in the main body and that regulate an insertion depth of the nozzle;
a guide rib configured to guide an insertion of the nozzle, the guide rib projecting in a direction intersecting a projecting direction of the pair of stopper ribs, and extending parallel to the flow path formed on the inner surface of the flow path, wherein
the pair of stopper ribs project inward toward each other,
a shortest distance between the pair of stopper ribs is set to be smaller than an outer diameter of a distal end of the nozzle,
the guide rib has a front edge located in front of rear edges of the pair of stopper ribs in an insertion direction of the nozzle, and
a height of the guide rib from the inner surface is a height in which an insertion of the nozzle is guided such that a portion of the distal end of the nozzle having a maximum width in the projecting direction abuts against the pair of stopper ribs.

2. A capless fuel filler assembly configured to be attached to a distal end of a filler pipe extending from a fuel tank, the capless fuel filler assembly comprising:
a main body having a fuel filler through which a nozzle of a filler gun is inserted;
a flap valve for opening and closing the fuel filler, that is disposed in the main body such that the flap valve can be opened and closed;
at least one stopper rib that projects inward from an inner surface of a flow path of a liquid fuel formed in the main body and that regulates an insertion depth of the nozzle;
a guide rib ofr guiding an insertion of the nozzle, the guide rib projecting in a direction intersecting a projecting direction of the stopper rib, and extending parallel to the flow path formed on the inner surface of the flow path, wherein
a shortest distance between the stopper rib and the inner surface of the flow path facing a distal end of the stopper rib is set to be smaller than an outer diameter of a distal end of the nozzle,
the guide rib has a front edge is located in front of a rear edge of the stopper rib in an insertion direction of the nozzle, and
a height of the guide rib from the inner surface is the height in which an insertion of the nozzle is guided such that a portion of the distal end of the nozzle having a maximum width in the projecting direction abuts against the stopper rib.

3. (canceled)

4. (canceled)
